(19) United States
(12) Patent Application Publication
(10) Pub. No.: US 2005/0163498 A1
(43) Pub. Date: Jul. 28, 2005

(54) User interface for automatic red-eye removal in a digital image

(76) Inventors: Amy E. Battles, Windsor, CO (US); Christopher A. Whitman, Fort Collins, CO (US); Dan L. Dalton, Greeley, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/767,355

(22) Filed: Jan. 28, 2004

(51) Int. Cl. H04N 5/217; G03B 15/03; G06K 9/40; G06K 9/00

(52) U.S. Cl. 396/158; 348/224.1; 348/241; 382/275; 382/163

(57) ABSTRACT

A user interface for red-eye removal allows a user selectively to accept or reject red-eye removal in candidate red-eye regions that are automatically detected in a digital image and presented to the user. A modified digital image may be produced and saved in which red-eye removal is performed in the candidate red-eye regions the user accepts.

### FIELD OF THE INVENTION

The present invention relates generally to digital photography and more specifically to user interfaces used in conjunction with techniques for removing the red-eye effect in digital images.

### BACKGROUND OF THE INVENTION

A pervasive problem in flash photography is the red-eye effect, in which an on-camera flash reflects off the back of the eyes of a subject, causing the eyes to appear red. The problem is so common that many digital photo-editing applications include an automatic or manual red-eye removal feature. Automatic red-eye removal is not foolproof, however, and manual red-eye removal can become tedious for the user.

It is thus apparent that there is a need in the art for an improved user interface for automatic red-eye removal in a digital image.

### SUMMARY OF THE INVENTION

A method for removing the red-eye effect in a digital image is provided. An apparatus for carrying out the method is also provided.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1A is a high-level block diagram of a digital camera in accordance with an illustrative embodiment of the invention.

FIG. 1B is an illustration of the display and some of the input controls of the digital camera shown in FIG. 1A in accordance with an illustrative embodiment of the invention.

FIG. 1C is a high-level diagram of the memory of the digital camera shown in FIG. 1A in accordance with an illustrative embodiment of the invention.

FIG. 2 is a flowchart of the operation of the digital camera shown in FIGS. 1A-1C in accordance with an illustrative embodiment of the invention.

FIG. 3 is an illustration of a simplified digital image in which candidate red-eye regions are presented to a user in accordance with an illustrative embodiment of the invention.

FIG. 4A is an illustration of a simplified digital image in which a particular candidate red-eye region has been selected by a user in accordance with an illustrative embodiment of the invention.

FIG. 4B is an illustration of a simplified digital image in which a particular candidate red-eye region has been selected and rejected by a user in accordance with an illustrative embodiment of the invention.

FIG. 4C is an illustration of a simplified digital image in which a particular candidate red-eye region has been selected and rejected by a user in accordance with another illustrative embodiment of the invention.

FIG. 5 is an illustration of a simplified digital image on which a menu has been superimposed in accordance with an illustrative embodiment of the invention.

FIG. 6 is an illustration of a magnified and centered view of a selected candidate red-eye region within a simplified digital image in accordance with an illustrative embodiment of the invention.

### DETAILED DESCRIPTION OF THE INVENTION

Red-eye removal can be made more accurate and effective by automatically detecting one or more candidate red-eye regions in a digital image, presenting the candidate red-eye regions to a user, and allowing the user to accept or reject interactively red-eye removal in individual candidate red-eye regions. A modified digital image may then be produced in which red-eye removal is applied only to the candidate red-eye regions the user has accepted, and the resulting modified digital image may be saved.

Although this detailed description presents the principles of the invention in the context of a digital camera, the principles of the invention may be applied to a variety of other settings, including, but not limited to, digital camcorders, desktop personal computers (PCs), workstations, notebook computers, laptop computers, and personal digital assistants (PDAs). That is, the invention is applicable to any apparatus capable of capturing and/or storing digital images and manipulating them.

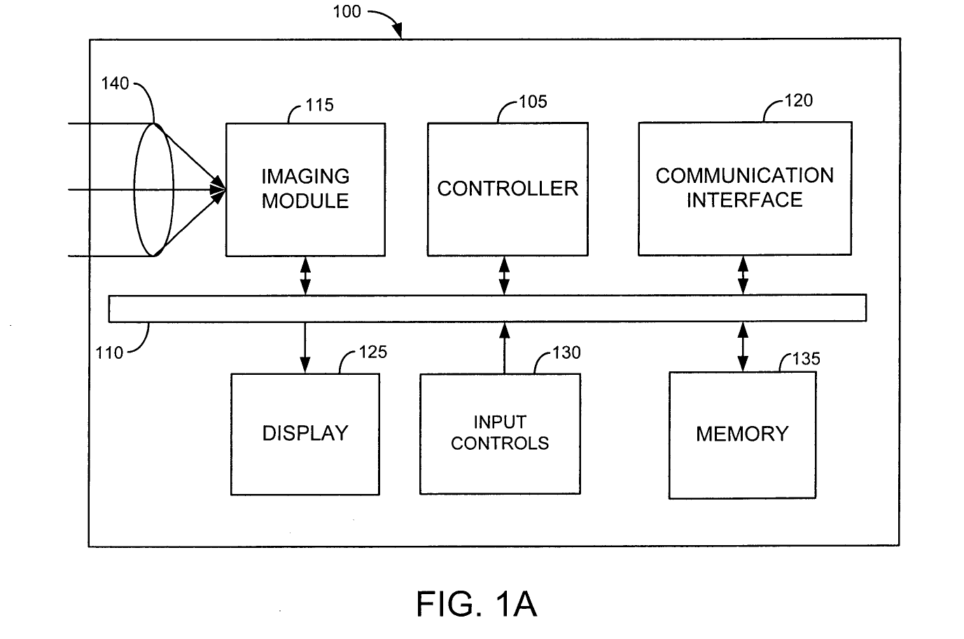

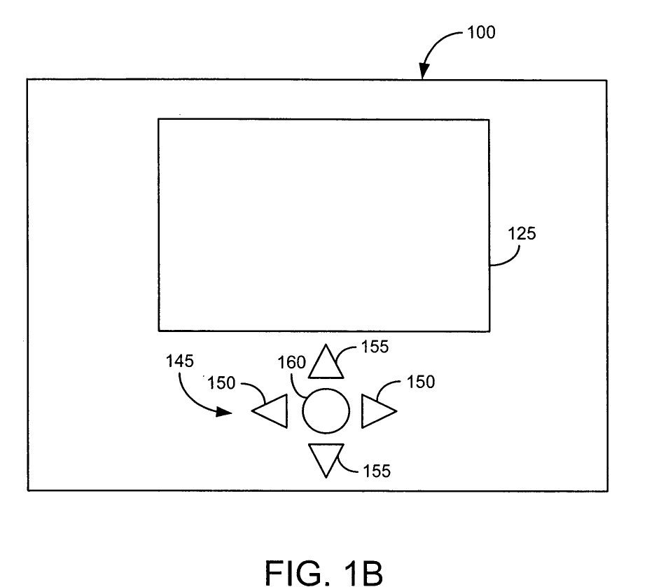

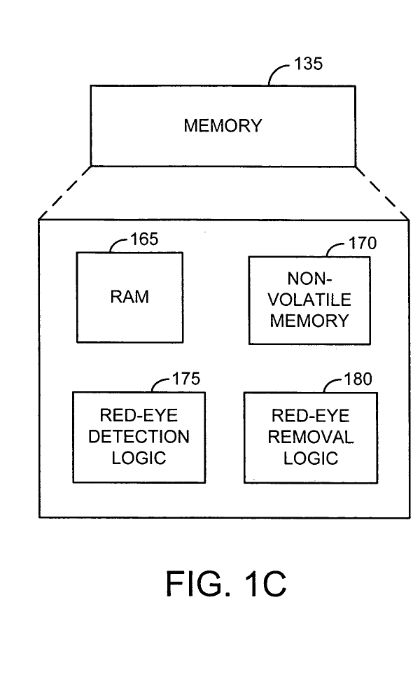

FIG. 1A is a high-level block diagram of a digital camera 100 in accordance with an illustrative embodiment of the invention. In FIG. 1A, controller 105 communicates over data bus 110 with imaging module 115, communication interface 120, display 125, input controls 130, and memory 135. Optical system 140 produces optical images that are converted to digital images by imaging module 115. Controller 105 may comprise a microprocessor or microcontroller. Imaging module 115 may comprise an array of photosensors based on charge-coupled-device (CCD), CMOS, or other image sensing technology; an analog-to-digital converter (A/D); a gain control; and a digital signal processor (DSP) (not shown in FIG. 1A). Communication interface 120 may be of the hard-wired variety, such as Universal Serial Bus (USB) or Firewire (IEEE 1394), or it may be wireless, such as Bluetooth or IEEE 802.11. Communication interface 120 may be used to transfer digital image data from digital camera 100 to an external device such as a PC. Display 125 may comprise a liquid crystal display (LCD). Input controls 130 may include navigational controls (e.g., directional-arrow controls), a menu/“ok” button, a shutter release button, or other controls, physical or virtual, for controlling the operation of digital camera device 100.

FIG. 1B is an illustration of display 125 and some of the input controls 130 of digital camera 100 in accordance with an illustrative embodiment of the invention. In FIG. 1B, digital camera 100 may include a set of navigational controls 145 comprising two pairs of opposing directional controls, horizontal directional controls 150 and vertical directional controls 155, and menu/“ok” button 160. These controls may be physical buttons, or they may be virtual buttons on, e.g., a touch-sensitive screen. Navigational controls 145 may be used, for example, to navigate among and give focus to items on display 125. Menu/“ok” button 160 may be used to call up a menu on display 125 and may double as an “ok” button (much like an “enter” key on a computer keyboard).

FIG. 1C is a high-level diagram of memory 135 of digital camera 100 in accordance with an illustrative embodiment of the invention. In general, memory 135 may comprise both random access memory (RAM) 165 and non-volatile memory 170, which may be of the removable variety (e.g., a secure digital or multi-media memory card). Memory 135 may further comprise red-eye detection logic 175 and red-eye removal logic 180. Red-eye detection logic 175 may detect one or more candidate red-eye regions in a digital image and present them on display 125. Automatic red-eye detection and removal techniques are well known in the digital image processing art. Examples include U.S. Pat. No. 6,278,491 and pending U.S. patent application Ser. No. 10/653,019, both assigned to Hewlett-Packard Company, the disclosures of which are incorporated herein by reference. The former reference employs face detection; the latter does not. Red-eye removal logic 180 performs red-eye removal (e.g., according to the techniques described in the cited references) in the candidate red-eye regions of a digital image that a user has accepted. Those candidate red-eye regions that the user rejects remain unmodified. Essentially, red-eye removal involves replacing red pixels with those of a more suitable color where the red-eye effect has occurred in a digital image. User interfaces by which the user may accept or reject individual candidate red-eye regions will be described in a later portion of this detailed description. Red-eye detection logic 175 and red-eye removal logic 180 may be implemented as software, firmware, hardware, or any combination thereof. In one embodiment, red-eye detection logic 175 and red-eye removal logic 180 may be stored program instructions residing in firmware that are executed by controller 105.

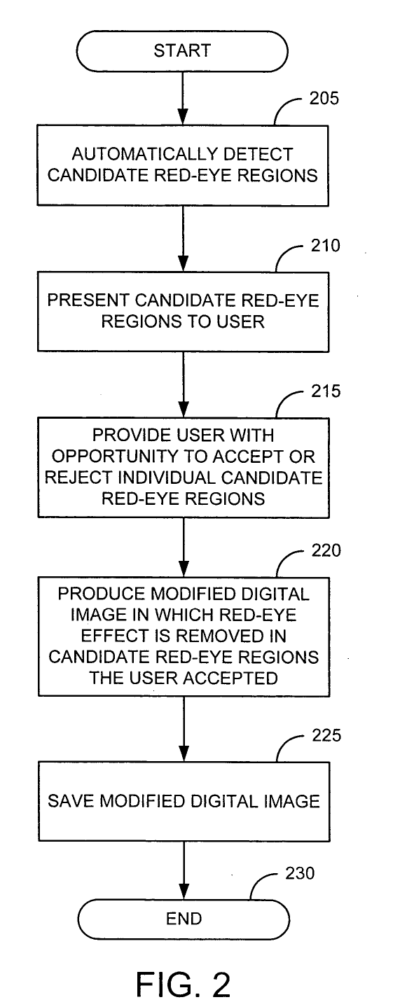

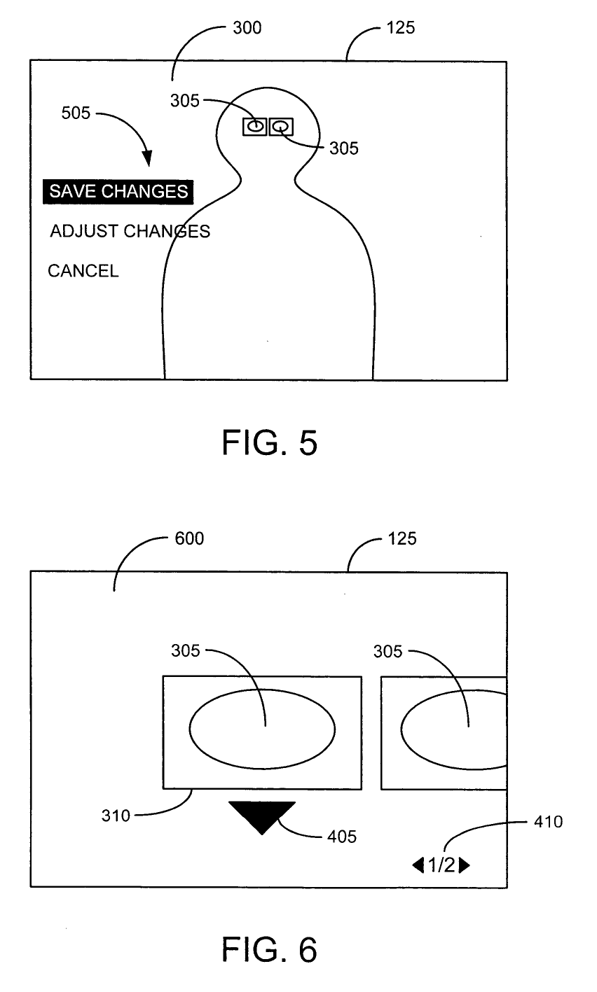

FIG. 2 is a flowchart of the operation of digital camera 100 in accordance with an illustrative embodiment of the invention. At 205, in response to a request from a user to remove the red-eye effect in a digital image, red-eye detection logic 175 may analyze a digital image to detect automatically one or more candidate red-eye regions in the digital image. A candidate red-eye region is one that meets the criteria of the applicable red-eye detection algorithm. Red-eye detection logic 175 may present the candidate red-eye regions to the user on display 125 at 210. At 215, the user may accept or reject individual candidate red-eye regions. If all candidate red-eye regions are correct, the user may accept red-eye removal in all of the candidate red-eye regions by, for example, simply invoking a menu and saving the modified digital image (see steps 220 and 225 and FIG. 5). At 220, red-eye removal logic 180 may produce a modified digital image by performing red-eye removal in the candidate red-eye regions that the user has accepted, those the user has rejected remaining unmodified. The modified digital image may be saved at 225, after which the process may terminate at 230.

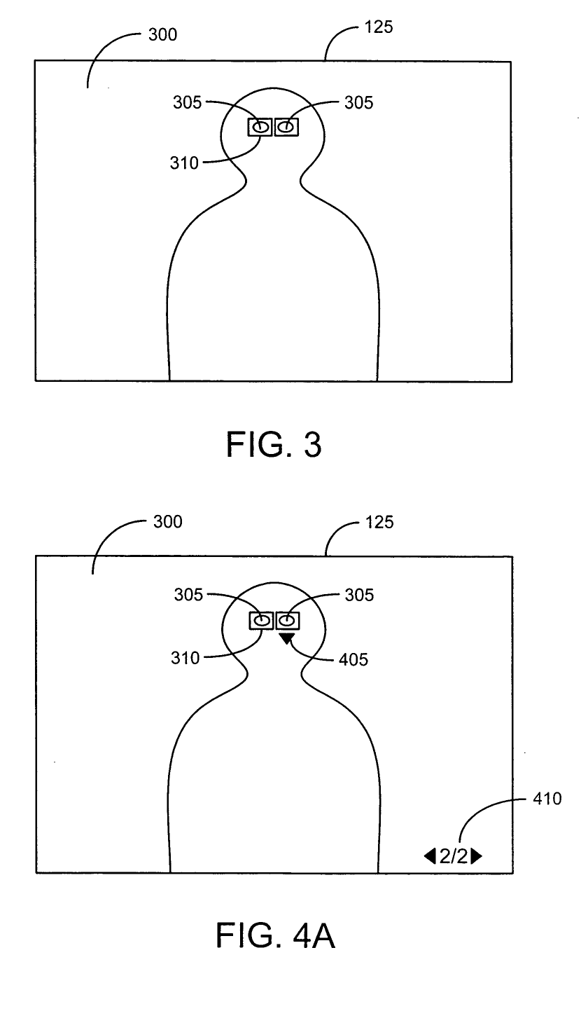

The specifics of how candidate red-eye regions are presented to the user and the manner in which the user may accept or reject individual candidate red-eye regions may vary depending on the application. FIGS. 3-6 show some illustrative embodiments. However, a wide variety of variations are possible, all of which are considered to be within the scope of the invention as claimed.

FIG. 3 is an illustration of a simplified digital image in which candidate red-eye regions are presented to a user in accordance with an illustrative embodiment of the invention. In FIG. 3, digital image 300 contains a human subject in which two candidate red-eye regions 305 have been identified by red-eye detection logic 175. In presenting candidate red-eye regions 305 to a user, it is helpful to mark candidate red-eye regions 305 in some way. In the example of FIG. 3, each candidate red-eye region 305 is enclosed within a geometrical figures 310, in this case a rectangle. Other geometrical figures 310 may be used, or candidate red-eye regions may be marked in some other way (e.g., a pointing arrow icon). All candidate red-eye regions 305 may be presented to the user simultaneously, as shown in FIG. 3, or the user interface of digital camera 100 may be configured to guide the user from one candidate red-eye region 305 to the next sequentially, allowing the user to accept or reject each as it is presented.

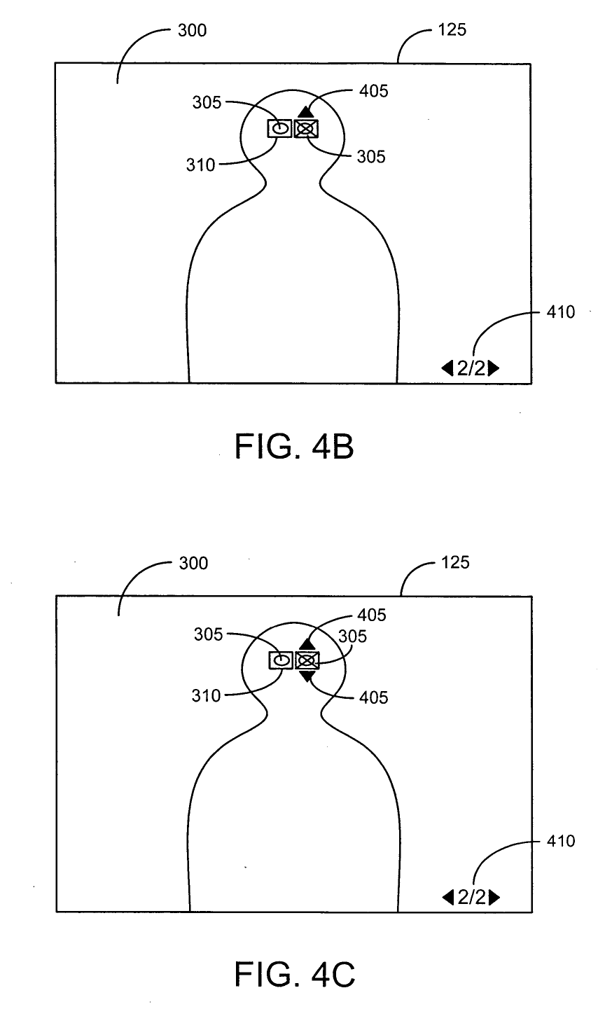

In embodiments in which all candidate red-eye regions are presented to the user simultaneously, it is desirable to provide the user with a way of navigating among the candidate red-eye regions 305 and giving focus to (selecting) a particular candidate red-eye region 305 to accept or reject. FIGS. 4A-4C show two ways in which this may be accomplished in accordance with illustrative embodiments of the invention. In general, horizontal directional controls 150 may be used to navigate among the candidate red-eye regions 305 to give focus to (select) a particular candidate red-eye region 305. Vertical directional controls 155 may be used to accept or reject a particular selected candidate red-eye region 305.

In FIG. 4A, the user has selected the rightmost of the two candidate red-eye regions 305 using horizontal directional controls 150. In some embodiments, the selected candidate red-eye region 305 may be in the “accepted” state by default until the user indicates otherwise. In the view in which candidate red-eye regions 305 are presented to the user on display 125, the candidate red-eye regions 305 may be shown corrected (with red-eye removal already performed), or the candidate red-eye regions may be shown uncorrected until the user has decided which candidate red-eye regions 305 to accept. To prompt the user that actuating down-arrow control 155 will reject the selected candidate red-eye region 305, an icon 405 representing down-arrow control 155 may be placed below the geometrical figure 310 enclosing selected candidate red-eye region 305. Optionally, display 125 may also indicate which candidate red-eye region 305 is currently selected (i.e., which has focus). In FIG. 4A, an indicator 410 in the form M/N is provided, where the currently selected candidate red-eye region 305 is the Mth candidate red-eye region 305 of N total candidate red-eye regions 305. In the particular example of FIG. 4A, the selected candidate red-eye region 305 is the second of two candidate red-eye regions; therefore, indicator 410 is “2/2.” In some embodiments, geometrical figure 310 may be drawn more boldly or in a different color to indicate which candidate red-eye region 305 is currently selected.

In FIG. 4B, the user has actuated down-arrow control 155 in the context of FIG. 4A to reject the selected candidate red-eye region 305 (the rightmost candidate red-eye region 305 in FIG. 4B). In this example, rejection is indicated by drawing an “x” through the geometrical figure 310 enclosing the selected candidate red-eye region 305. In this case, an icon 405 representing up-arrow control 155 may be placed above the geometrical figure 310 enclosing the selected candidate red-eye region 305 to prompt the user that pressing up-arrow control 155 will accept the selected candidate red-eye region 305. The state of acceptance or rejection of a candidate red-eye region 305 may be indicated in a variety of ways other than a superimposed “x,” all of which are considered to be within the scope of the invention as claimed. For example, the geometrical figure 310 enclosing the candidate red-eye region 305 may be altered in some other way, such as a change of shape or color.

In FIG. 4C, a different approach is employed to accept or reject a selected candidate red-eye region 305. Two icons 405 representing vertical directional controls 155 (up-arrow and down-arrow controls 155) may be placed above and below the geometrical figure 310 enclosing selected candidate red-eye region 305, as shown in FIG. 4C, to indicate that actuating either vertical directional control 155 (up-arrow or down-arrow control 155) will toggle the state (acceptance or rejection) of the selected candidate red-eye region 305.

Optionally, icons representing horizontal directional controls 150 may be placed near indicator 410 or near the currently selected candidate red-eye region 305 to indicate that horizontal directional controls 150 may be used to navigate among the candidate red-eye regions 305.

FIG. 5 is an illustration of simplified digital image 300 on which a menu 505 has been superimposed in accordance with an illustrative embodiment of the invention. Menu 505 may be presented first after the user requests red-eye removal in digital image 300, or the user may be brought directly to an “adjust changes” view such as that illustrated in FIGS. 4A-4C. If Menu 505 is presented first, the candidate red-eye regions 305 may be presented to the user (e.g., marked as shown in FIGS. 3, 4A-4C, and 5), and the user may accept all of the proposed corrections simultaneously by simply executing “Save Changes.” Menu 505 also allows the user to save the modified digital image after adjusting changes (selectively accepting or rejecting candidate red-eye regions 305) or to cancel the red-eye removal operation entirely. Menu 505 may be invoked and individual commands thereof executed using, for example, menu/“ok” button 160.

In some applications, it may be useful for digital camera 100 (or whatever device in which the invention is embodied) to show a magnified view (zoomed in view) of the selected candidate red-eye region 305, either automatically or in response to manual input from the user (e.g., using the zoom lever of digital camera 100). FIG. 6 shows one example of how this may be done in accordance with an illustrative embodiment of the invention. In FIG. 6, the first (leftmost) candidate red-eye region 305 of simplified digital image 300 (see FIGS. 4A-5) has been selected and zoomed to produce a magnified digital image 600. Optionally, the selected candidate red-eye region 305 may be centered automatically on display 125, as shown in FIG. 6. In some embodiments, presenting the magnified, centered view of FIG. 6 may be performed animatedly. In such an embodiment, as the user navigates to a different candidate red-eye region 305, the magnified, centered view of magnified digital image 600 may also be updated animatedly.

The foregoing description of the present invention has been presented for the purposes of illustration and description. It is not intended to be exhaustive or to limit the invention to the precise form disclosed, and other modifications and variations may be possible in light of the above teachings. The embodiments were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

1. A method for removing red-eye effect in a digital image, comprising:
detecting automatically at least one candidate red-eye region within the digital image;
presenting the at least one candidate red-eye region to a user; and
producing a modified digital image by performing red-eye removal in each candidate red-eye region that the user accepts, each candidate red-eye region that the user rejects remaining unmodified.

2. The method of claim 1, further comprising:
saving the modified digital image.

3. The method of claim 1, wherein a plurality of candidate red-eye regions are detected within the digital image.

4. The method of claim 3, wherein the plurality of candidate red-eye regions are presented to the user one at a time.

5. The method of claim 3, wherein the plurality of candidate red-eye regions are presented to the user simultaneously.

6. The method of claim 5, wherein a first pair of opposing directional controls is used to select a particular candidate red-eye region and a second pair of opposing directional controls is used to perform one of acceptance and rejection of the particular candidate red-eye region.

7. The method of claim 6, wherein the first pair of opposing directional controls comprises horizontal directional controls and the second pair of opposing directional controls comprises vertical directional controls.

8. The method of claim 1, wherein an indication is provided that a selected candidate red-eye region is the Mth candidate red-eye region of N total candidate red-eye regions in the plurality.

9. The method of claim 1, wherein presenting the at least one candidate red-eye region to a user comprises marking the at least one candidate red-eye region.

10. The method of claim 9, wherein marking the at least one candidate red-eye region comprises enclosing the at least one candidate red-eye region within a geometrical figure.

11. The method of claim 9, wherein at least one icon accompanying a selected candidate red-eye region indicates how the user is to accept the selected candidate red-eye region.

12. The method of claim 9, wherein at least one icon accompanying a selected candidate red-eye region indicates how the user is to reject the selected candidate red-eye region.

13. The method of claim 1, wherein an indication is provided of whether the at least one candidate red-eye region has been accepted by the user.

14. The method of claim 1, wherein presenting the at least one candidate red-eye region to a user includes zooming in to show an enlarged view of a selected candidate red-eye region.

15. The method of claim 14, wherein the enlarged selected candidate red-eye region is automatically centered on a display.

16. The method of claim 1, wherein all candidate red-eye regions are accepted simultaneously.

17. An apparatus, comprising:
a memory to store a digital image;
red-eye detection logic to detect automatically at least one candidate red-eye region in the digital image;
a display on which to present the at least one candidate red-eye region to a user;
a user interface by which the user indicates whether to accept the at least one candidate red-eye region; and
red-eye removal logic to produce a modified digital image by performing red-eye removal in each candidate red-eye region that the user accepts, each candidate red-eye region that the user rejects remaining unmodified.

18. The apparatus of claim 17, further comprising:
an imaging module to convert an optical image to the digital image;

19. The apparatus of claim 17, wherein the user interface comprises a first pair of opposing directional controls to select a particular candidate red-eye region and a second pair of opposing directional controls to perform one of acceptance and rejection of the particular candidate red-eye region.

20. The apparatus of claim 19, wherein the first pair of opposing directional controls comprises horizontal directional controls and the second pair of opposing directional controls comprises vertical directional controls.

21. The apparatus of claim 17, wherein the user interface is configured to zoom in to show an enlarged view of a selected candidate red-eye region.

22. The apparatus of claim 21, wherein the user interface is further configured to center the enlarged selected candidate red-eye region on the display.

23. The apparatus of claim 17, wherein the apparatus is one of a digital camera, a digital camcorder, a personal computer, a workstation, a notebook computer, a laptop computer, and a personal digital assistant.

24. An apparatus, comprising:
means for storing a digital image;
means for automatically detecting at least one candidate red-eye region in the digital image;
means for presenting the at least one candidate red-eye region to a user;
means for the user to indicate whether to accept the at least one candidate red-eye region; and
means for producing a modified digital image by performing red-eye removal in each candidate red-eye region that the user accepts, each candidate red-eye region that the user rejects remaining unmodified.

25. The apparatus of claim 24, further comprising:
means for converting an optical image to the digital image;
